(19) United States
(12) Patent Application Publication
(10) Pub. No.: US 2025/0249941 A1
(43) Pub. Date: Aug. 7, 2025

(54) Automated Warning System for Uncontrolled Railroad Crossings

(71) Applicant: Robert HO, Reston, VA (US)

(72) Inventor: Robert HO, Reston, VA (US)

(21) Appl. No.: 18/981,492

(22) Filed: Dec. 14, 2024

Related U.S. Application Data
(60) Provisional application No. 63/549,421, filed on Feb. 2, 2024.

(51) Int. Cl. B61L 29/30; B61L 15/00; B61L 25/02; G01S 19/13

(52) U.S. Cl. CPC B61L 29/30; B61L 15/0018; B61L 25/025; G01S 19/13; B61L 2205/04

(57) ABSTRACT

The present invention comprises an automated warning system for uncontrolled railway crossings. This system has elements which include a real-time communication low earth orbit satellite system in conjunction with mobile devices, a crossing satellite beacon, a crossing motion detection system, and a real-time situational monitoring system that establishes warning alerts to both the train operator and vehicle operator all on a real-time basis. The present invention's various elements together are meant to address the inherent dangers of uncontrolled railway crossings by providing cost-effective improvements that will reduce tragic accidents/loss of life, reduce lawsuits and damages.

### CROSS REFERENCE TO RELATED APPLICATIONS

The present application claims the benefit of U.S. Provisional patent application Ser. No. 63/549,421, filed Feb. 2, 2024, entitled AUTOMATED WARNING SYSTEM FOR UNCONTROLLED RAILROAD CROSSINGS.

### BACKGROUND OF THE INVENTION

An automated warning system for uncontrolled railway crossings. A system that utilizes low earth orbit satellites and other communication and sensor apparatus to alert both in-transit railroad engine operators, and in-transit vehicle operators approaching an uncontrolled railway crossing.

There is a long history of preventable tragic accidents at uncontrolled railway crossings. According to the NHTSA website, “injuries and deaths occur at rail crossings every day. In 2021 more than 1, 600 collisions between vehicles and freight and commuter trains, and nearly 500 collisions at transit train crossings in 2020. The result: 133 people died and 644 people injured. Most of these tragedies are preventable.” In June 2022 4 people were killed and 140 people injured when an Amtrak train hit a dump truck at an uncontrolled crossing causing both locomotives and passenger railcars to derail. The NTSB report found that the truck driver proceeded for unknown reasons into the uncontrolled railway crossing despite the presence of a stop sign and an approaching train. Contributing to the collision was the crossing design which reduced drivers' ability to see approaching trains and proceeded the required stop as required by law. There have been multiple lawsuits associated with this tragic accident and the estimated damage to track and equipment is about $4 million.

An uncontrolled railway crossing is a location on the railway where traffic is not controlled by a traffic control device, a crossing gate, or a flag person. In other words, there are no active warning devices at these locations. An uncontrolled railway crossing may or may not have passive alerts such as a warning sign. They lack visible road markings, lack physical barriers such as gates, and visibility is often limited. At these crossings, it is the responsibility of the vehicle operator's judgment and awareness. Moreover, the train operator is completely unaware of the potential of an approaching vehicle. Uncontrolled railway crossings exist for several reasons: remote locations, unjustifiable cost for implementing a controlled railroad crossing, many crossings are private not public.

Recent technical developments permit a cost-effective solution for alerting rail engine operators and vehicle operators. There is a need in the field for an automated warning system at uncontrolled railway crossings.

### SUMMARY OF THE INVENTION

The present invention comprises an automated warning system for uncontrolled railway crossings. This system may comprise elements at least one of a real-time communication low earth orbit satellite system in conjunction with GNSS satellite system, satellite-capable mobile devices, a crossing satellite beacon, a crossing motion detection system, and/or elements establishing warning alerts to both the train operator and vehicle operator all on a real-time basis.

The present invention's various elements together may address the inherent dangers of uncontrolled railway crossings by providing cost-effective improvements that will reduce tragic accidents/loss of life, reduce lawsuits and damages.

### BRIEF DESCRIPTION OF DRAWINGS

FIG. 1—FIG. 1 depicts a bird's eye view of the automated warning system.

FIG. 2—FIG. 2 depicts an example of a vehicle operator's view on a mobile device.

FIG. 3—FIG. 3 depicts an example of a train operator's view on a mobile device.

FIG. 4—FIG. 4 depicts at an uncontrolled railway crossing, the action of a beacon to an approaching vehicle using its motion sensors.

FIG. 5—FIG. 5 depicts the actions of real-time automated warning system where potential collision may be prevented when virtual perimeter is triggered.

FIG. 6—FIG. 6 depicts the actions of real-time automated warning system where potential collision may be prevented when motion sensor is triggered.

FIG. 7—FIG. 4 depicts at an uncontrolled railway crossing, the action of a beacon to an approaching vehicle when virtual perimeter is triggered.

### DETAILED DESCRIPTION OF THE INVENTION

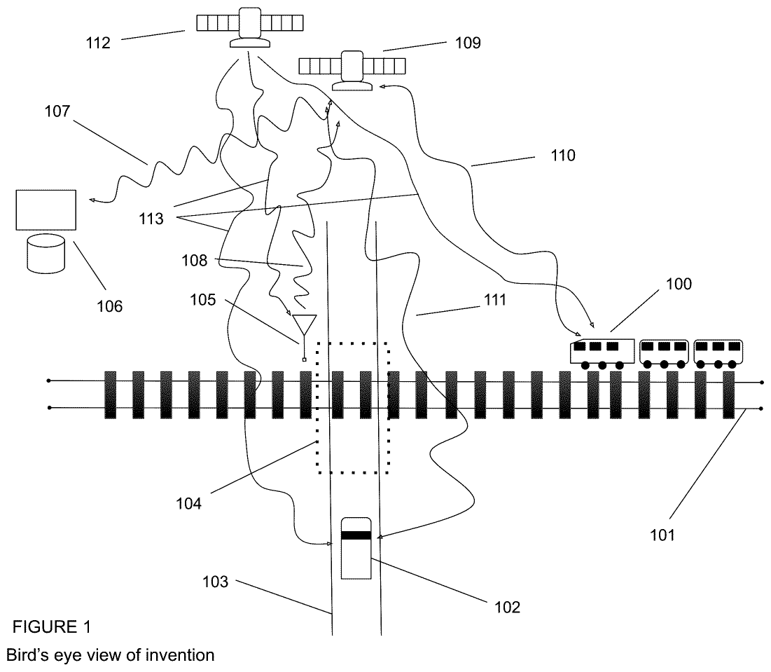

The present invention is described by referencing appended figures and reference numerals. In FIG. 1, the bird's eye view of this invention depicts and comprises of several elements that may work in conjunction together to provide an automated warning system for uncontrolled railroad crossings according to various embodiments of the present invention.

With reference to FIG. 1, in the present invention of the automated warning system for uncontrolled railroad crossings, the automated warning system may comprise of real-time low earth orbit (LEO) satellite constellation system 109 and real-time situational analysis system 106. Uncontrolled railway crossings 104 may be located in geographic remote locations where terrestrial communication network coverage is sparse or non-existent. Line of sight may be limited around uncontrolled railway crossings due to forestry, not a straight clear line of sight approach, gradient, and such. The LEO satellite constellation system 109 may provide real-time network communication coverage to the uncontrolled railway crossings 104. The real-time situation analysis system 106 may provide real-time situation monitoring at an uncontrolled railway crossing 104. This real-time situation system 106 may be configured to be automated, such that a computational algorithm may be monitoring the real-time location of both approaching vehicle 102 and train 100, and tracking their proximity to the uncontrolled railroad crossing 104. Further, the real-time situation system 106 may be co-located to a LEO satellite ground station.

Continuing with reference to FIG. 1, the automated warning system may comprise ground elements, such as train 100, vehicle 102 and/or crossing beacon 105. The train 100 may be traveling on train tracks 101. The train may comprise a LEO satellite-capable transceiver or similar satellite-capable mobile device for bidirectional communication 110 with the real-time situational analysis system 106 via the LEO satellite constellation system 109, the bidirectional communication 107 between real-time situational monitoring system 106. The train may comprise a Global Navigation Satellite System (GNSS) receiver to receive the train's earth location from the GNSS satellite 112 by unidirectional communication 113. Similarly, the vehicle 102 may be traveling on the road 103. The vehicle may comprise a LEO satellite-capable transceiver or similar satellite-capable mobile device for bidirectional communication 111 with the real-time situational monitoring system 106 via the LEO satellite constellation system 109, the bidirectional communication 107 between real-time situational monitoring system 106, and may have a GNSS receiver to receive the vehicle's earth location from the GNSS satellite 112 by unidirectional communication 113. The crossing beacon 105 may have a LEO satellite-capable transponder for unidirectional communication 108 from the beacon to the LEO satellite system 109, may have a GNSS receiver to receive its earth location from the GNSS satellite 112 by unidirectional communication 113. The crossing beacon may register its earth location as an uncontrolled railway crossing to the real-time situational monitoring system 106.

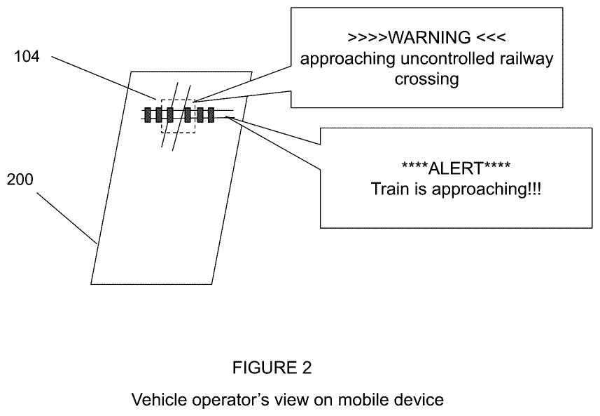

With reference to FIG. 2 this figure depicts a vehicle operator's perspective (driving in vehicle 102). A LEO-satellite capable Mobile Device may display to the vehicle operator a graphical representation of approaching uncontrolled railway crossing 104 with a warning showing on a LEO-satellite capable Mobile Device, and may be alerted to a potential train 100 approach. Referring back to FIG. 1, vehicle 102 may receive real-time information warning from real-time situational monitoring system 106 that the vehicle 102 is approaching the uncontrolled railway crossing 104 and/or a train 100 may be approaching the crossing. In a preferred embodiment, the direct-to-device technology (e.g., LEO satellite to mobile phone) may be further considered for this automated warning system. The direct-to-device technology may combine network of both LEO satellite and terrestrial network operators for cost effectiveness.

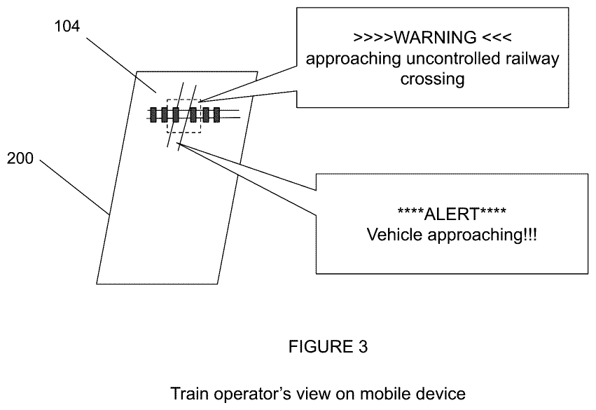

With reference to FIG. 3, this figure depicts a train operator's perspective (driving train 100). A LEO-satellite capable Mobile Device may display to the train operator a graphical representation of approaching uncontrolled railway crossing 104 with a warning as shown on a LEO-satellite capable Mobile Device and may be alerted to a potential vehicle 102 approach. Referring back to FIG. 1, train 100 may receive real-time information warning from real-time situational monitoring system 106 that the train 100 may be approaching the uncontrolled railway crossing 104 and/or vehicle 102 may be approaching the crossing. In a preferred embodiment, the direct-to-device technology (e.g., LEO satellite to mobile phone) may be further considered for this automated warning system for cost effectiveness. In another embodiment, the train operator may be using a LEO-satellite transceiver.

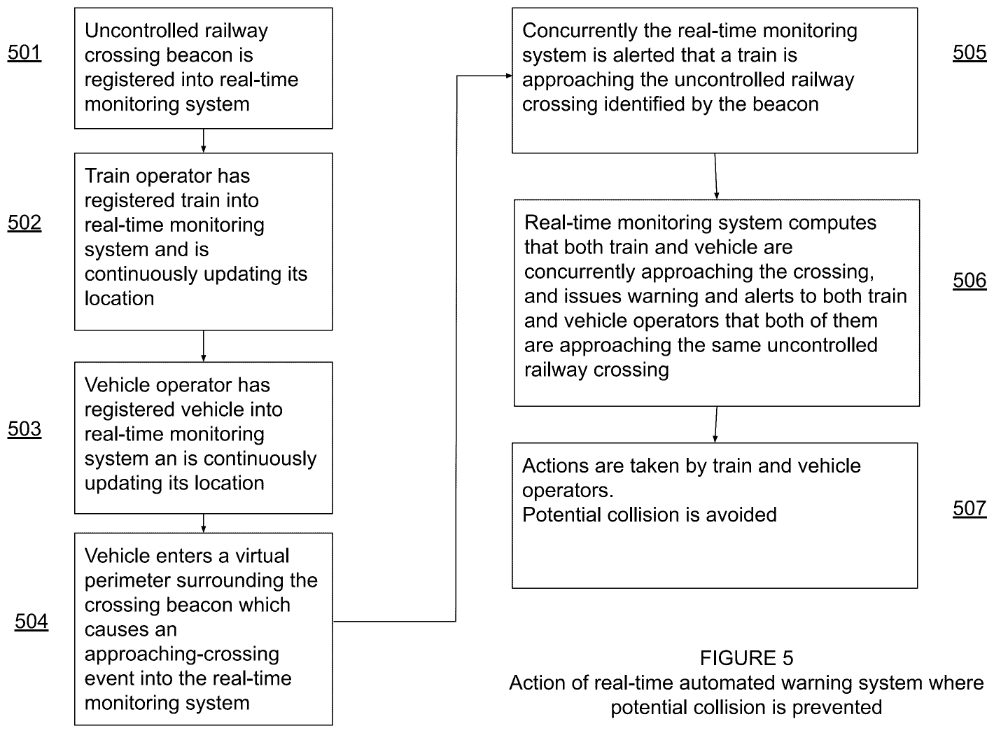

In reference to FIG. 5, this figure illustrates the basic events and actions in the present invention real-time automated warning system for an uncontrolled railway crossing. The crossing beacon may register its location and identify as uncontrolled railway crossing into the real-time situational monitoring system 501. Both the train's device and vehicle's device may be registered into the situational monitoring system. Both train and vehicle may be continuously updating their locations into the situational monitoring system 502 and 503. The situational monitoring system may track the locations of both the train and vehicle with respect to the crossing. In a preferred embodiment, a common service platform may exist whereby the vehicle, and train may register their respective devices.

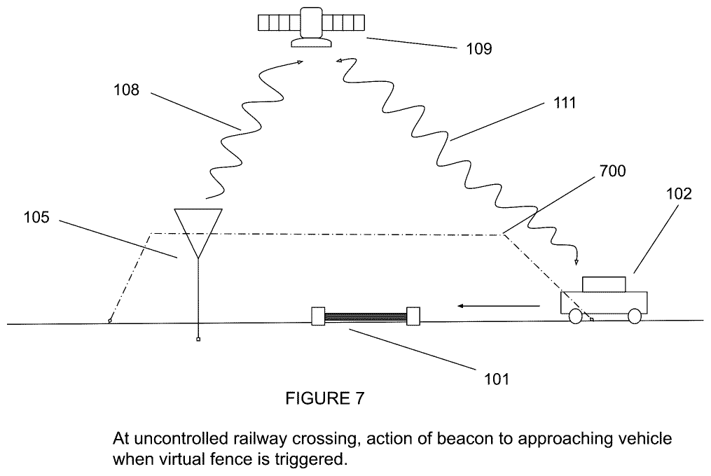

Continuing with reference to FIG. 5, the location of the uncontrolled railway crossing may be known to the situational monitoring system 106 and the situational monitoring system 106 may actively track the locations of both the vehicle and train. In 504 the situational monitoring system 106 may set up a virtual perimeter 700 as shown in FIG. 7 with respect to the beacon 105. A virtual perimeter may be a set of pre-determined coordinates distanced from the beacon. An illustrative example may be a rectangle-shaped perimeter. The perimeter may be wider or larger than the uncontrolled crossing 104. In 505 when vehicle 102 crosses the perimeter and travels towards the crossing and railroad tracks 101, a trigger event may be activated at the situational monitoring system 106. If a train 100 is in a proximity of the uncontrolled railway crossing 104, the situational monitoring system 106 may send an alert to the train that a vehicle is approaching the uncontrolled railway crossing 104. In 506 the vehicle driver may now be alerted as depicted in FIG. 2 and the train operator may be alerted as depicted in FIG. 3. In 507 appropriate safety actions may be undertaken by the vehicle driver or the train operator resulting in avoiding a tragic collision. In a preferred embodiment, a common service platform may exist whereby the vehicle, and train may be warned and altered to their respective devices

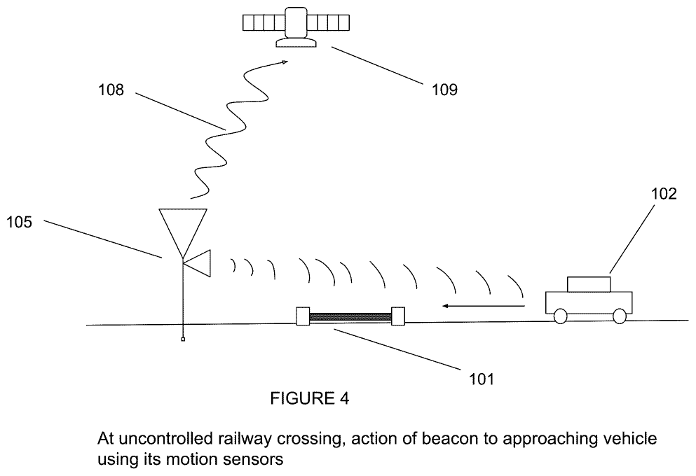

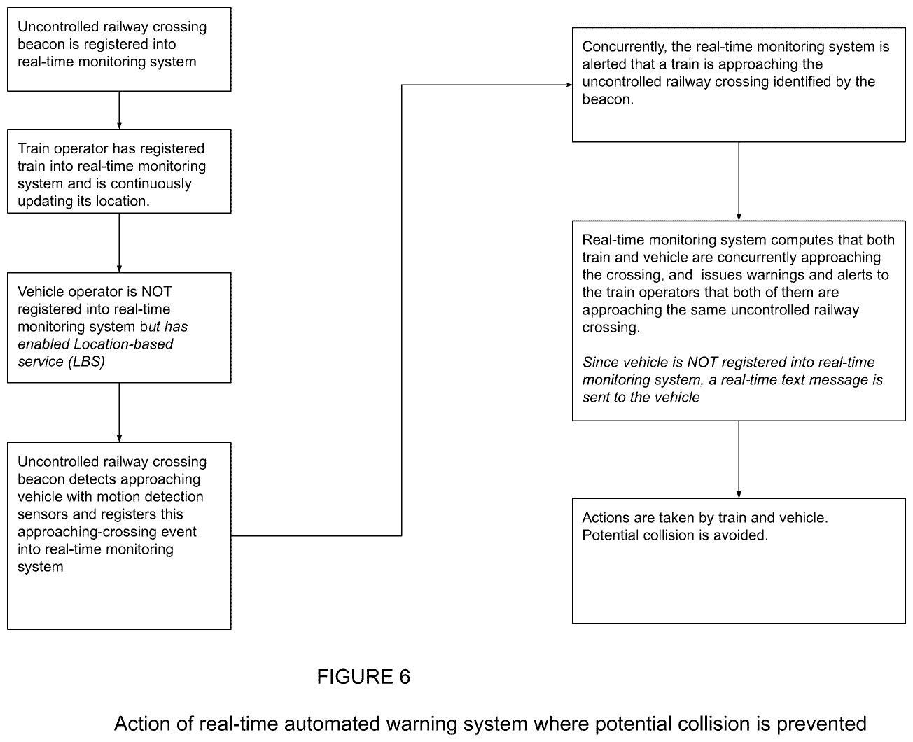

With reference to FIG. 4, in an alternate embodiment of the crossing beacon 105, there may be a motion-detecting sensor instead of a virtual perimeter (as stated above as a preferred embodiment). A motion-detecting sensor may be configured to be light detection and ranging (LIDAR), passive Infrared sensor, or any such type of motion-detecting technology appropriate for the scene. In this alternate embodiment, the vehicle may not be registered into real-time situational monitoring system but may have configured location-based services (LBS) enabled on the mobile device identifying itself to the monitoring system. An identification of the mobile device may be its internal mobile subscriber identity (IMSI). Similar to the preferred embodiment, a trigger event may be activated, and an alert may be sent to train 100. Since the vehicle may not be registered the situational monitor system may send a real-time SMS text message to the vehicle operator as depicted in FIG. 6.

In another embodiment, there may be a plurality of crossing beacons to increase reliable vehicle detection. In this embodiment, only a single crossing beacon may be configured for Over-the-Air communication.

1. An automated warning system for uncontrolled railway crossings comprising:
real-time communication low-earth orbit satellite system establishing communications with mobile devices, real-time situational system and uncontrolled railway crossing beacon;
low-earth orbit-capable mobile device on vehicle configured to provide real-time geolocation and bidirectional communication with low-earth orbit satellite system;
low-earth orbit-capable mobile device on train configured to provide real-time geolocation and bidirectional communication with low-earth orbit satellite system;
a real-time situational monitoring system configured to provide bidirectional communication; and managing collision prevention of train and vehicles;
an uncontrolled railway crossing beacon configured to provide unidirectional communication to real-time situational monitoring system; and
and said crossing beacon configured for GNSS reception.

2. The automated warning system for uncontrolled railway crossings according to claim 1, wherein uncontrolled railway crossing beacons is configured to assist real-time situational monitoring system establish a virtual perimeter.

3. The automated warning system for uncontrolled railway crossings according to claim 1, wherein uncontrolled railway crossing beacons is configured with motion detection sensors to detect approaching vehicles.
